(19) United States
(12) Patent Application Publication
(10) Pub. No.: US 2026/0091314 A1
(43) Pub. Date: Apr. 2, 2026

(54) DISPLAY APPARATUS AND GAME PICTURE QUALITY CONTROL METHOD

(71) Applicant: HISENSE VISUAL TECHNOLOGY CO., LTD., Shandong (CN)

(72) Inventors: Xinlei YU, Shandong (CN); Fang LIU, Shandong (CN); Yinghao HE, Shandong (CN)

(21) Appl. No.: 19/412,306

(22) Filed: Dec. 8, 2025

Related U.S. Application Data
(63) Continuation of application No. PCT/CN2024/089653, filed on Apr. 24, 2024.

(30) Foreign Application Priority Data
Jun. 13, 2023 (CN) 202310702160.X

(51) Int. Cl. A63F 13/52; A63F 13/533; A63F 13/60; G06F 3/14

(52) U.S. Cl. CPC A63F 13/52; A63F 13/533; A63F 13/60; G06F 3/14

(57) ABSTRACT

The display device includes: a display, a user input interface, a communication apparatus, a memory and at least one processor connected to the display, the user input interface, the communication apparatus and the memory, and the at least one processor is configured to: in response to a received input signal of a game device, identify a first signal type of the input signal, and determine a game picture quality parameter corresponding to the first signal type; acquire a first game interaction mode, and determine a picture quality parameter offset corresponding to the first game interaction mode under the first signal type; calculate a target picture quality parameter according to the game picture quality parameter corresponding to the first signal type and the picture quality parameter offset corresponding to the first game interaction mode; and control the display to display a game picture according to the target picture quality parameter.

### CROSS REFERENCE TO RELATED APPLICATIONS

The application is a continuation application of International Application No. PCT/CN2024/089653, filed on Apr. 24, 2024, which claims the priority to Chinese Patent Application No. 202310702160.X, filed to the China National Intellectual Property Administration on Jun. 13, 2023, which is incorporated in its entirety herein by reference.

### TECHNICAL FIELD

The disclosure herein relates to the technical field of a display apparatus, and in particular to a display apparatus and a method for controlling game image quality.

### BACKGROUND

To meet the gaming entertainment needs of users, a display apparatus support connecting to game devices such as game controllers. Currently, the display apparatus displays a game screen based on a set of fixed image quality parameters in a game mode. However, the effect of the game screen displayed based on the fixed image quality parameters is difficult to adapt to the increasingly diverse game scenarios. Therefore, a display apparatus that can automatically update the effect of the game screen is urgently needed.

### SUMMARY

In a first aspect, the present disclosure provides a display apparatus, including: a display configured to display an image and/or a user input interface; the user input interface configured to receive a command from a user; a communication device configured to communicate with an external device according to a predetermined protocol; a memory configured to store computer instructions and data associated with the display apparatus; at least one processor connected to the display, the user input interface, the communication device and the memory, and configured to execute the computer instructions to cause the display apparatus to perform: in response to receiving an input signal of a game device, identifying a first signal type of the input signal, and determining a game image quality parameter corresponding to the first signal type; obtaining a first game interaction mode, and determining an image quality parameter offset corresponding to the first game interaction mode under the first signal type; calculating a target image quality parameter according to the game image quality parameter corresponding to the first signal type and the image quality parameter offset corresponding to the first game interaction mode; and controlling the display to display a game screen according to the target image quality parameter.

In a second aspect, the present disclosure provides a method for controlling game image quality, including: in response to receiving an input signal of a game device, identifying a first signal type of the input signal, and determining a game image quality parameter corresponding to the first signal type; obtaining a first game interaction mode, and determining an image quality parameter offset corresponding to the first game interaction mode under the first signal type; calculating a target image quality parameter according to the game image quality parameter corresponding to the first signal type and the image quality parameter offset corresponding to the first game interaction mode; and controlling a display to display a game screen according to the target image quality parameter.

### BRIEF DESCRIPTION OF FIGURES

FIG. 1 is a schematic diagram of a scenario in some embodiments.

FIG. 2 is a block diagram of a configuration of a control device 100 according to some embodiments.

FIG. 3 is a block diagram of a hardware configuration of a display apparatus 200 according to some embodiments.

FIG. 4 is a schematic diagram of software configuration in a display apparatus 200 according to some embodiments.

FIG. 5 is a schematic flow chart of a method for controlling game image quality according to some embodiments.

FIG. 6 is a first schematic diagram of a setting interface of a display apparatus according to some embodiments.

FIG. 7 is a second schematic diagram of a setting interface of a display apparatus according to some embodiments.

FIGS. 8a and 8b are a first schematic diagram of switching of a game device according to some embodiments.

FIGS. 9a and 9b are a second schematic diagram of switching of a game device according to some embodiments.

FIG. 10 is a schematic diagram of a voice input according to some embodiments.

### DETAILED DESCRIPTION

At present, a display apparatus on the market configures a set of fixed image quality parameters for game devices in game mode, and the display apparatus displays a game screen based on these fixed image quality parameters. However, game development is moving towards multiple game scenarios, and users have higher and higher requirements for gaming experience. The existing game screen effects displayed based on fixed image quality parameters are difficult to adapt to a wide variety of game scenarios, affecting the user experience in multiple game scenarios. Therefore, there is an urgent need for a display apparatus that can automatically update the game screen effect to adapt to multiple game scenarios.

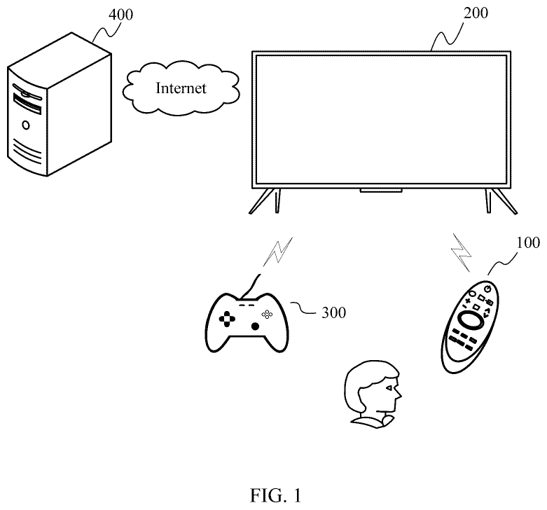

FIG. 1 is a schematic diagram of a scene in some embodiments. As shown in FIG. 1, a user can operate a display apparatus 200 through a game device 300 or a control device 100 to display a game screen on the display apparatus 200.

In the scenario shown in FIG. 1, taking an example of a user operating the display apparatus 200 through the game device 300, the game device 300 can be connected to the display apparatus 200 through a high-definition multimedia interface (HDMI). In response to receiving an input signal of the game device 300, the display apparatus 200 identifies a first signal type of the input signal, and determines a game image quality parameter corresponding to the first signal type, then obtains a first game interaction mode and determines an image quality parameter offset corresponding to the first game interaction mode under the first signal type, and then calculates a target image quality parameter according to the game image quality parameter corresponding to the first signal type and the image quality parameter offset corresponding to the first game interaction mode, so as to control a display to display a game screen according to the target image quality parameter. In the embodiments of the present disclosure, the target image quality parameter for displaying the game screen is calculated based on the game image quality parameter corresponding to the game device and the image quality parameter offset corresponding to the game interaction mode, so that the game image quality effect no longer depends only on fixed image quality parameters, and can be combined with the game interaction mode to achieve adjustment and offset of the game image quality, so as to adapt to a variety of game interaction modes in multiple game scenes, so that the image quality effect of the game screen is more diversified, thereby improving the scene adaptability of the game image quality and enhancing the user's gaming experience.

In some embodiments, the control device 100 may be a remote controller, and the communication between the remote controller and the display apparatus includes infrared protocol communication, Bluetooth protocol communication. The display apparatus 200 is controlled in a wireless manner or other wired manners. The user may input a user command through buttons on the remote controller, voice input, control panel input, etc. to control the display apparatus 200. In some embodiments, a mobile terminal, a tablet computer, a computer, a laptop computer, and other smart devices may also be used to control the display apparatus 200.

In some embodiments, the game device 300 can be a game controller, an electronic game console (PlayStation or xbox), etc., and the present disclosure does not limit this. The game device 300 can install software applications with the display apparatus 200, and realize connection communication through a network communication protocol to achieve the purpose of one-to-one control operation and data communication. The display apparatus 200 can be allowed to communicate and connect with the other networks through a local area network (LAN), a wireless local area network (WLAN). The server 400 can provide various content and interactions to the display apparatus 200. The display apparatus 200 can be a liquid crystal display, an OLED display, or a projection display device. In addition to providing a broadcast receiving television function, the display apparatus 200 can also provide an intelligent network TV function that provides a computer support function.

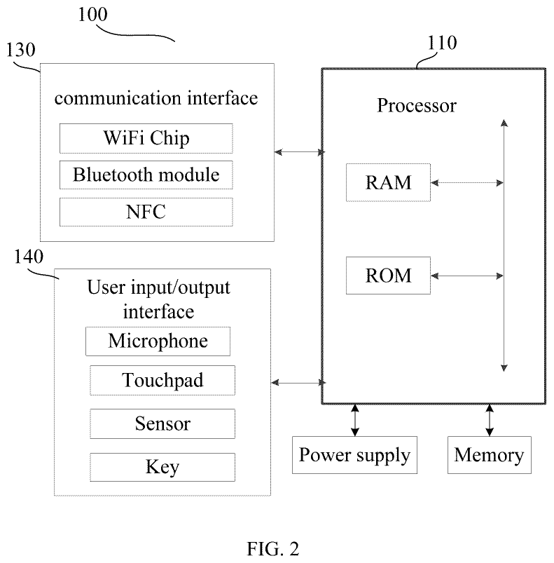

FIG. 2 is a configuration block diagram of a control device 100 according to some embodiments. As shown in FIG. 2, the control device 100 includes a processor 110, a communication interface 130, a user input/output interface 140, a memory, and a power supply. The control device 100 can receive an operation command input from the user, and convert the operation command into an instruction that can be recognized and responded to by the display apparatus 200, and act as an interactive intermediary between the user and the display apparatus 200. The communication interface 130 is used to communicate with the outside, and includes a WIFI (Wireless Fidelity, mobile hotspot) chip, a Bluetooth module, NFC or at least one of an alternative module. The user input/output interface 140 includes at least one of a microphone, a touchpad, a sensor, a button or an alternative module.

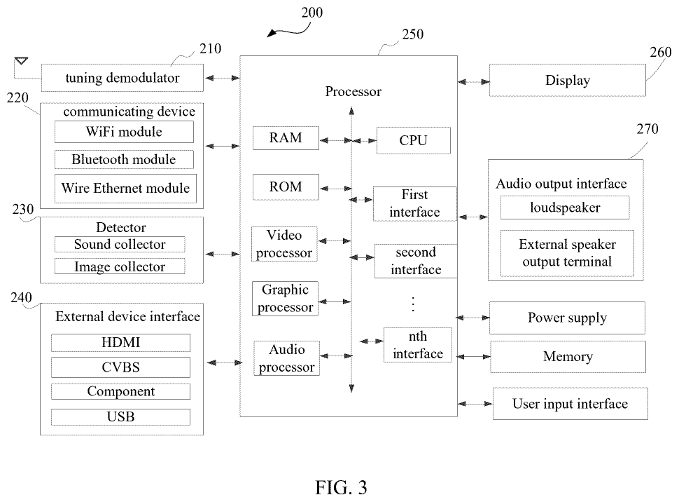

FIG. 3 is a hardware configuration block diagram of a display apparatus 200 according to some embodiments. As shown in FIG. 3, the display apparatus 200 includes: a tuning demodulator 210, a communicating device 220, a detector 230, an external device interface 240, a processor 250, a display 260, an audio output interface 270, a memory, a power supply, etc. The processor 250 includes a central processing unit, a video processor, an audio processor, a graphics processor, a RAM, a ROM, and a first interface to an nth interface for input/output. The display 260 may be at least one of a liquid crystal display, an OLED display, a touch display, and a projection display, and may also be a projection device and a projection screen. The tuning demodulator 210 receives broadcast television signals in a wired or wireless reception manner, and demodulates audio and video signals from multiple wireless or wired broadcast television signals, such as and EPG data signals. The detector 230 is used to collect signals of the external environment or interact with the outside. The processor 250 and the tuning demodulator 210 may be located in different separate devices, that is, the tuning demodulator 210 may also be located in an external device of the main device where the processor 250 is located, such as an external set-top box.

In some embodiments, the display apparatus 200 is a terminal device with a display function, such as a television, a mobile phone, a computer, a learning machine, etc.

In some embodiments, the processor 250 controls the operation of the display apparatus and responds to the user's operation through various software control programs stored in the memory. The processor 250 controls the overall operation of the display apparatus 200. The user may input a user command through the graphical user interface (GUI) displayed on the display 260, and the user input interface receives the user command through the graphical user interface (GUI). Alternatively, the user may input a user command by inputting a specific sound or gesture, and the user input interface recognizes the sound or gesture through a sensor to receive the user command.

The output interface (display 260 and/or audio output interface 270) is configured to output user interaction information; the communication device 220 is used to communicate with the server 400 or other devices.

According to some embodiments, a display apparatus 200 is provided, at least one processor in the display apparatus 200 is configured to: in response to receiving an input signal of a game device, identify a first signal type of the input signal, and determine a game image quality parameter corresponding to the first signal type; obtain a first game interaction mode, and determine an image quality parameter offset corresponding to the first game interaction mode under the first signal type; calculate a target image quality parameter according to the game image quality parameter corresponding to the first signal type and the image quality parameter offset corresponding to the first game interaction mode; and control a display to display a game screen according to the target image quality parameter.

The above-mentioned display apparatus 200 controls the image quality of the game screen based on the game image quality parameter corresponding to the game device and the obtained image quality parameter offset corresponding to the game interaction mode, so that the image quality effect of the game screen no longer depends solely on fixed image quality parameters, and the game image quality can be adjusted by combining the image quality parameters and the image quality parameter offsets of different game interaction modes to adapt to different game scenes, thereby improving the image quality effect of the game screen and further improving the user's gaming experience.

In some embodiments, the at least one processor is configured to execute computer instructions to cause the display apparatus to perform: in response to receiving the input signal of the game device, identifying the first signal type of the input signal, and determining the game image quality parameter corresponding to the first signal type, by: in response to receiving the input signal of the game device, identifying the first signal type of the input signal; retrieving the game image quality parameter corresponding to the first signal type from a first database. The first database is configured to store different game image quality parameters corresponding to different signal types.

In some embodiments, the first game interaction mode is obtained and the image quality parameter offset corresponding to the first game interaction mode under the first signal type is determined, and the at least one processor is configured to: in response to receiving a selection command input from the user, retrieve the image quality parameter offset corresponding to the first game interaction mode from a second database. The selection command is configured to indicate the first game interaction mode selected by the user, and the second database is configured to store different image quality parameter offsets corresponding to different game interaction modes.

In some embodiments, the at least one processor is configured to execute the computer instructions to cause the display apparatus to perform: obtaining the first game interaction mode and determining the image quality parameter offset corresponding to the first game interaction mode under the first signal type, by: identifying a game scene, determining the first game interaction mode corresponding to the game scene, the first game interaction mode being any one of a standard mode, a first-person shooting mode, a role-playing mode, a real-time strategy mode, or a sports mode; retrieving the image quality parameter offset corresponding to the first game interaction mode from a second database, the second database being configured to store different image quality parameter offsets corresponding to different game interaction modes.

In some embodiments, the at least one processor is further configured to execute the computer instructions to cause the display apparatus to perform: based on that a switching signal is received and the switching signal indicates that the game device connected to the display apparatus is switched, identifying a second signal type corresponding to the switching signal; based on that the second signal type is different from the first signal type, obtaining a historical image quality parameter corresponding to the second signal type. The historical image quality parameter is an image quality parameter of the first game interaction mode under the second signal type stored in history; and controlling the display to update image quality of the game screen according to the historical image quality parameter corresponding to the second signal type.

In some embodiments, the at least one processor is further configured to execute the computer instructions to cause the display apparatus to perform: in response to a voice input indicating a switch to a second game interaction mode, obtaining an image quality parameter offset corresponding to the second game interaction mode under the first signal type; calculating an image quality parameter to be switched according to the game image quality parameter corresponding to the first signal type and the image quality parameter offset corresponding to the second game interaction mode; and controlling the display to update image quality of the game screen according to the image quality parameter to be switched.

In some embodiments, the first signal type of the input signal includes: a high dynamic range type, a standard dynamic range type and a Dolby type; the first game interaction mode includes: a standard mode, a first-person shooting mode, a role-playing mode, a real-time strategy mode, a sports mode and an automatic mode, and different first game interaction modes under different first signal types correspond to different image quality parameter offsets.

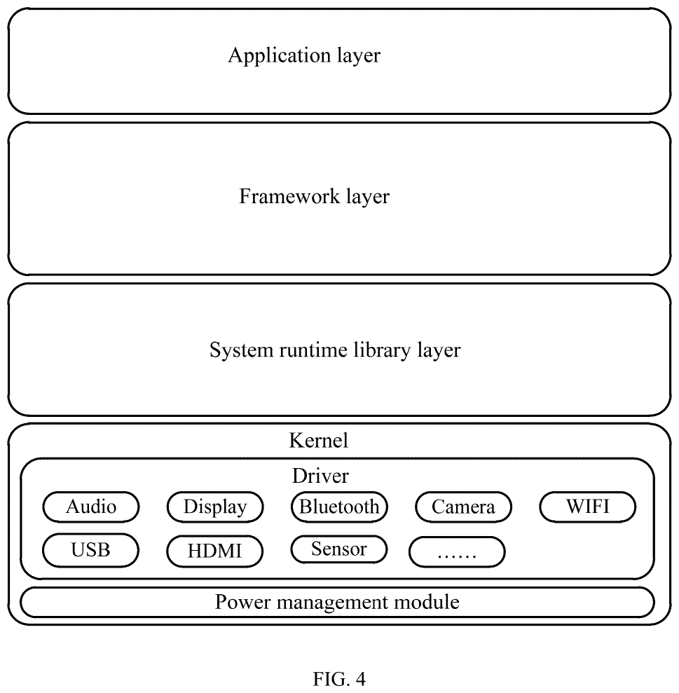

As shown in FIG. 4, FIG. 4 is a schematic diagram of a software configuration of a display apparatus 200 according to some embodiments. As shown in FIG. 4, the system is divided into four layers, which are respectively an applications layer (hereinafter referred to as the “Application layer”), an application framework layer (hereinafter referred to as the “framework layer”), an android runtime and system library layer (hereinafter referred to as the “system runtime library layer”), and a kernel layer. The kernel layer includes at least one of the following drivers: an audio driver, a display driver, a Bluetooth driver, a camera driver, a WIFI driver, a Universal Serial Bus (USB) driver, a HDMI driver, a sensor driver (such as a fingerprint sensor, a temperature sensor, a pressure sensor, etc.), and a power driver, etc.

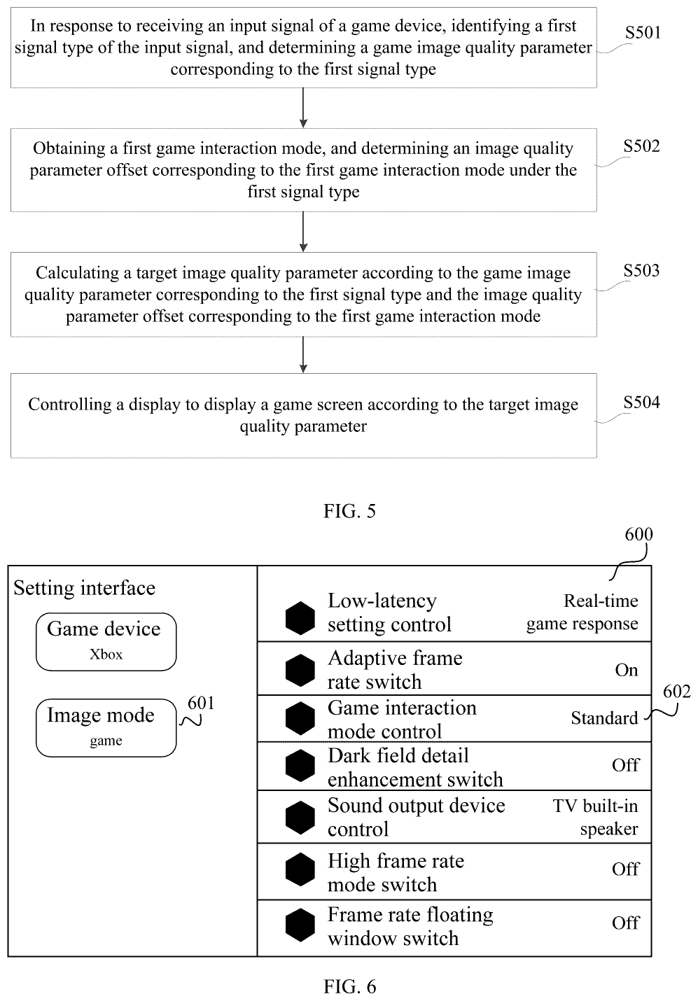

In order to explain the present solution in more detail, it will be explained in an exemplary manner in conjunction with FIG. 5 below. It can be understood that the steps involved in FIG. 5 may include more steps or fewer steps in actual implementation, and the order of these steps may also be different, so as to implement the game image quality control method provided in the embodiment of the present disclosure.

As shown in FIG. 5, FIG. 5 is a schematic flow chart of a method for controlling game image quality according to some embodiments, the method includes the following steps S501 to S504.

S501, in response to receiving an input signal of a game device, identifying a first signal type of the input signal, and determining a game image quality parameter corresponding to the first signal type.

In some embodiments, the display apparatus is connected to the game device via the HDMI, and the input signal of the game device may be an HDMI signal. The first signal type of the input signal includes, but is not limited to, a high dynamic range type (High Dynamic Range Imaging, HDR), a standard dynamic range type (Standard Dynamic Range, SDR), and Dolby type (DOLBY). Different first signal types correspond to different game image quality parameters. As shown in Table 1.

TABLE 1

| first signal type | game image quality parameter |
|---|---|
| HDR | A |
| SDR | B |
| DOLBY | C |

Table 1 is only an exemplary description. The display apparatus can store Table 1 in the first database in advance to store a correspondence between the first signal type and the game quality parameters. It can be understood that the first database is used to store different game quality parameters corresponding to different signal types. It should be noted that different game quality parameters corresponding to different signal types can be stored in the first database of the display apparatus in different data forms such as lists (e.g., Table 1) and sets, and the data in the first database are not fixed, but support operations such as addition, deletion, and modification to configure, manage, and maintain the data.

Among them, the game image quality parameter includes but is not limited to at least one of the following: a backlight parameter, an image brightness, contrast, chroma, or definition.

In some embodiments, in response to the input signal of the game device, the first signal type of the input signal is identified, and then the game image quality parameter corresponding to the first signal type is retrieved from the first database, thereby being able to distinguish game devices of different signal types connected to the display apparatus, and then controlling the game image quality in a targeted manner, thereby achieving different game image quality effects for different game devices.

In some embodiments, as shown in FIG. 6, FIG. 6 is a first schematic diagram of a setting interface of a display apparatus according to some embodiments. When a game device is connected to the display apparatus, in response to receiving an input signal of the game device (the input signal indicates that an image mode of the display apparatus is switched to a game mode, indicating that the user expects to display the game through the display apparatus), a setting interface 600 as shown in FIG. 6 is displayed. In the setting interface 600, an image mode control 601 shows that a current image mode is a game mode, and a game interaction mode control 602 (also referred to as a game type control) is shown. Other controls are also displayed in the above-mentioned setting interface 600, such as a low-latency setting control, an adaptive frame rate switch, a dark field detail enhancement switch, a sound output device control, a high frame rate mode switch, a frame rate floating window switch, etc., and the present invention does not limit this. As shown in FIG. 6, each control in the setting interface has an adjustable parameter value. Taking the adaptive frame rate switch as an example, its parameter value includes on and off, when the parameter value is set to on, it means that the adaptive function of the frame rate is on, and when the parameter value is set to off, it means that the adaptive function of the frame rate is off.

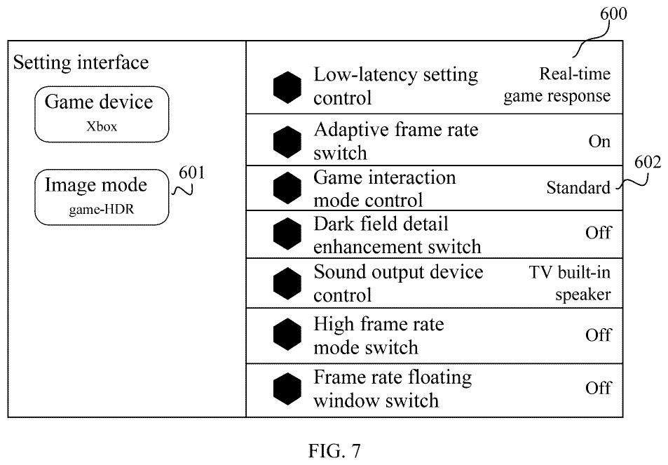

In some embodiments, after identifying the first signal type of the input signal in response to receiving the input signal of the game device, the display is controlled to display the identified first signal type in the setting interface. As shown in FIG. 7, FIG. 7 is a second schematic diagram of a setting interface of the display apparatus according to some embodiments, and the image mode control 601 in the setting interface 600 shown can display the game mode-HDR, to show the user that the display apparatus is switched to the game mode under HDR. The display of other controls in the setting interface 600 shown in FIG. 7 is the same as that shown in FIG. 6, and the present disclosure will not be repeated here. The parameter values of each control in the setting interface shown in FIG. 6 and FIG. 7 are merely exemplary and do not constitute a limitation on the configuration of image quality parameters under a specific content type.

S502: obtaining a first game interaction mode, and determining an image quality parameter offset corresponding to the first game interaction mode under the first signal type.

In some embodiments, the first game interaction mode includes but is not limited to: a standard mode, a first-person shooting mode (First-person shooting game, FPS), a role-playing mode (Role-Playing game, RPG), a real-time strategy mode (Real-Time Strategy Game, RTS), a sports mode and an automatic mode.

Herein, FPS is a shooting game played from the subjective perspective of a player; RPG is a game in which the player is responsible for playing a role in a realistic or fictional world; RTS is a strategy game played in real time. The automatic mode can intelligently switch to other game interaction modes according to the game screen.

The embodiments of the present disclosure support users to select the first game interaction mode by themselves, and also support the display apparatus to automatically identify the game scene to determine the first game interaction mode. Optionally, an acquisition method of the first game interaction mode is identified by retrieving the automatic mode flag (AutoFlag). When AutoFlag=0, it indicates that the first game interaction mode is obtained by the user operating the setting interface; when AutoFlag=1, it indicates that the first game interaction mode is obtained by identifying the game scene. It can be understood that by retrieving AutoFlag to determine whether the automatic mode is turned on, if AutoFlag=0, the automatic mode is turned off, then the first game interaction mode selected by the user is obtained; if AutoFlag=1, the automatic mode is turned on, then the game scene is identified to determine the first game interaction mode.

In some embodiments, in response to receiving a selection command input from the user, an image quality parameter offset corresponding to the first game interaction mode under the first signal type is determined, and the selection command indicates the first game interaction mode selected by the user. It is understandable that when AutoFlag=0, the user input is detected to determine the image quality parameter offset corresponding to the first game interaction mode under the first signal type when the user selects the first game interaction mode.

The image quality parameter offset corresponding to the first game interaction mode is set by the image quality engineer based on the standard mode, and the image quality parameter offset corresponding to the first game interaction mode includes but is not limited to: a backlight offset, an image brightness offset, a contrast offset, a chromaticity offset, and a definition offset. For example, the image quality parameter offsets corresponding to the standard mode are all 0.

Different first game interaction modes correspond to different image quality parameter offsets, specifically, values of the image quality parameter offsets are different. It should be emphasized that the image quality parameter offsets corresponding to the same first game interaction mode under different first signal types are different, as shown in Table 2.

TABLE 2

| first signal | first game | image quality |
|---|---|---|
| type | interaction mode | parameter offset |
| HDR | standard mode | a1 |
| | FPS | a2 |
| | RPG | a3 |
| | RTS | a4 |
| | sports mode | a5 |
| | automatic mode | a1/ a2/ a3/ a4/ a5 |
| SDR | standard mode | b1 |
| | FPS | b2 |
| | RPG | b3 |
| | RTS | b4 |
| | sports mode | b5 |
| | automatic mode | b1/ b2/ b3/ b4/ b5 |
| DOLBY | standard mode | c1 |
| | FPS | c2 |
| | RPG | c3 |
| | RTS | c4 |
| | sports mode | c5 |
| | automatic mode | c1/ c2/ c3/ c4/ c5 |

Table 2 is for illustrative purposes only. The display apparatus may pre-store Table 2 in a second database to store the image quality parameter offset corresponding to the first game interaction mode under the first signal type. It can be understood that the second database is used to store different image quality parameter offsets corresponding to different game interaction modes.

In the above embodiments, in response to receiving the selection command input from the user, the image quality parameter offset corresponding to the first game interaction mode is retrieved from the second database.

Exemplarily, if the selection command input from the user indicates that the first game interaction mode selected by the user is FPS, assuming that the first signal type determined according to step S501 is HDR, the image quality parameter offset corresponding to the first game interaction mode (i.e., FPS) under the first signal type (i.e., HDR) retrieved from the second database is a2.

In some embodiments, the game scene is identified, the first game interaction mode corresponding to the game scene is determined, and then the image quality parameter offset corresponding to the first game interaction mode is retrieved from the second database. It can be understood that when AutoFlag=1, the automatic mode is turned on, and the user operates the display apparatus to enter the game screen, the game screen is displayed in the standard mode by default, and the display apparatus can identify the game scene of the currently displayed game screen to determine the first game interaction mode corresponding to the game scene, and then determine the image quality parameter offset corresponding to the first game interaction mode under the first signal type. Thus, the automatic control of the image quality of the game screen is achieved, thereby enhancing the user experience.

In the process of identifying the game scene, the game content (including but not limited to text content for describing the game) can be obtained and analyzed to determine the game scene, or image recognition can be performed on the game screen currently displayed on the display to identify and determine the game scene of the game screen through deep learning algorithms, artificial intelligence models, etc.

S503: calculating a target image quality parameter according to the game image quality parameter corresponding to the first signal type and the image quality parameter offset corresponding to the first game interaction mode.

In some embodiments, referring to Table 1 and Table 2 above, assuming that the first signal type is HDR and the first game interaction mode is FPS, the game image quality parameter corresponding to the first signal type is A, and the image quality parameter offset corresponding to the first game interaction mode is a2, and the target image quality parameter is calculated to be A+a2.

S504: controlling a display to display a game screen according to the target image quality parameter.

In some embodiments, the game image quality parameter corresponding to the first signal type and the image quality parameter offset corresponding to the first game interaction mode are superimposed to obtain the target image quality parameter, and then the game screen is displayed according to the target image quality parameter. Thus, different target image quality parameters are generated for different game devices and different first game interaction modes, so that the game screen is no longer displayed based on fixed image quality parameters, which is conducive to improving the image quality effect.

In some embodiments, based on that the display apparatus receives a switching signal and the switching signal indicates that the game device connected to the display apparatus is switched, a second signal type corresponding to the switching signal is identified, and then the second signal type is compared with the first signal type. When the second signal type is the same as the first signal type, the game screen is still displayed according to the target image quality parameter; when the second signal type is different from the first signal type, a historical image quality parameter corresponding to the second signal type is obtained, and the historical image quality parameter is an image quality parameter of the first game interaction mode under the second signal type stored in history. Further, the display is controlled to update the image quality of the game screen according to the historical image quality parameter corresponding to the second signal type.

The historical image quality parameter is historically stored and calculated according to the game image quality parameter corresponding to the second signal type and the image quality parameter offset corresponding to the first game interaction mode under the second signal type.

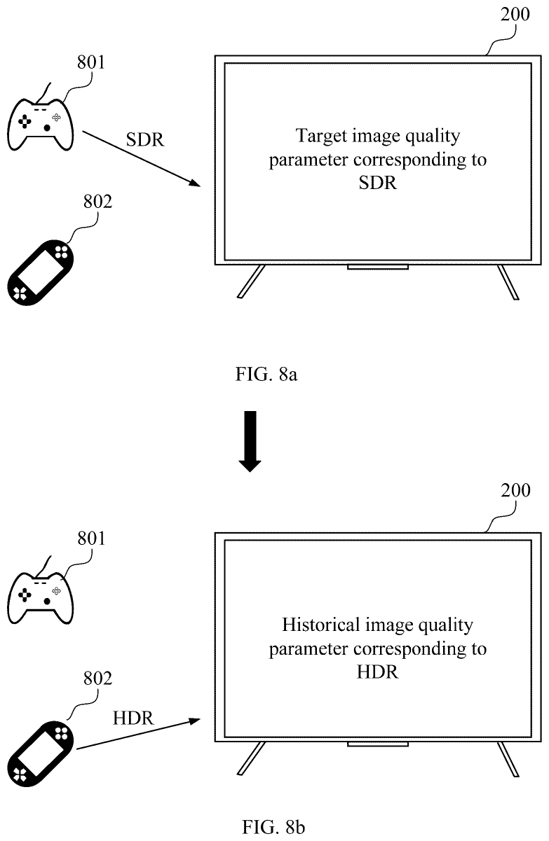

Exemplarily, as shown in FIGS. 8a and 8b, FIGS. 8a and 8b are a first schematic diagram of switching of a game device according to some embodiments. The figure shows that an external access device of the display apparatus 200 is switched from the first game device 801 shown in FIG. 8a to the second game device 802 shown in FIG. 8b. The signal type of the first game device 801 is different from the signal type of the second game device 802. For example, the signal type of the first game device 801 is SDR and the signal type of the second game device 802 is HDR. Then, the historical image quality parameter corresponding to HDR is obtained, so that the game screen displayed according to the target image quality parameter corresponding to SDR is updated to the game screen displayed according to the historical image quality parameter corresponding to HDR.

In the above-mentioned embodiments, when the game device connected to the display apparatus is switched, the signal types are compared to determine whether a change has occurred. If the change has occurred, it indicates that the image quality parameter of the game screen need to be updated, and after the signal type changes, the historical image quality parameter corresponding to the second signal type is called, thereby quickly responding to the switching of the connected device to achieve follow-up update of the game image quality, thereby improving the efficiency of game image quality update and enhancing the user experience.

In the above embodiments, when the second signal type is different from the first signal type, it is determined whether the game interaction mode has changed. Optionally, it is determined whether the game interaction mode has changed by detecting a user input command, or by identifying the game scene.

When no user instruction to switch the game interaction mode is detected or when a user input command indicating to maintain the first game interaction mode is detected, or when it is identified that the game scene has not changed, the historical image quality parameter corresponding to the second signal type is obtained, and the historical image quality parameter is the image quality parameter of the first game interaction mode under the second signal type stored historically. Furthermore, the display is controlled to update the target image quality parameter corresponding to the first signal type to the historical image quality parameter corresponding to the second signal type.

When detecting that the user input command indicates the switch from a first game interaction mode to a second game interaction mode, or when a game scene change is identified to determine switching from a first game interaction mode to a second game interaction mode, the game image quality parameter corresponding to the second signal type and the image quality parameter offset corresponding to the second game interaction mode under the second signal type are obtained, and then a new image quality parameter is calculated based on the game image quality parameter and the image quality parameter offset to control the display to update the target image quality parameter corresponding to the first signal type to the new image quality parameter, thereby adapting to the situation where the access device is switched and the game interaction mode changes, and improving the scene adaptability and flexibility of the image quality update.

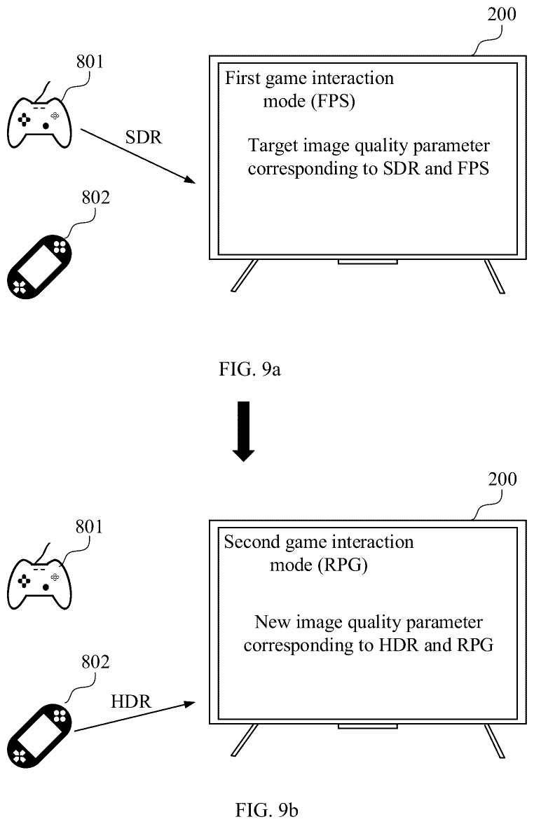

Next, as shown in FIGS. 9a and 9b, FIGS. 9a and 9b are a second schematic diagram of switching of a game device according to some embodiments, which shows that an external access device of the display apparatus 200 is switched from the first game device 801 shown in FIG. 9a to the second game device 802 shown in FIG. 9b. Assuming that the signal type of the first game device 801 is SDR, the signal type of the second game device 802 is HDR, and the game interaction mode is switched from the first game interaction mode (such as FPS) to the second game interaction mode (such as RPG), the game screen is updated from being displayed according to the target image quality parameter (B+b2) corresponding to SDR and FPS to being displayed according to the new image quality parameter (A+a3) corresponding to HDR and RPG.

In some embodiments, after the display apparatus controls the display to display the game screen according to the target image quality parameter, it may also continue to monitor a user input, and optionally monitor a voice input from the user, so as to update the image quality of the game screen. The embodiments of the present disclosure provide an implementation method: in response to receiving a voice input for indicating a switch to a second game interaction mode, an image quality parameter offset corresponding to the second game interaction mode under the first signal type is obtained, and then an image quality parameter to be switched is calculated according to the game image quality parameter corresponding to the first signal type obtained in step S501 and the image quality parameter offset corresponding to the second game interaction mode under the first signal type, and the display is further controlled to update the image quality of the game screen displayed currently according to the image quality parameter to be switched.

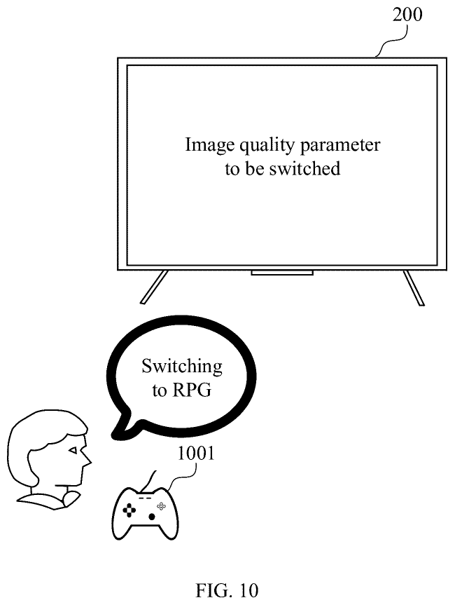

To facilitate understanding of the above process, as shown in FIG. 10 next, FIG. 10 is a schematic diagram of a voice input according to some embodiments. As shown in FIG. 10, it is difficult for the user to manually control the update of the game image quality when operating the game controller 1001 with both hands. Based on this, the display apparatus 200 provided by the embodiments of the present disclosure receives a voice input from the user. For example, the content of the voice input is “switch to RPG”, then the image quality parameter offset corresponding to RPG under the first signal type is obtained, and then the image quality parameter to be switched is calculated based on the image quality parameter offset corresponding to RPG under the first signal type and the game image quality parameter corresponding to the first signal type, and the game screen is updated from being displayed according to the target image quality parameter to being displayed according to the image quality parameter to be switched.

The above-mentioned embodiments can update the image quality of the game screen by voice control while the user is operating the game device with both hands, thereby improving the human-computer interaction performance and the user's gaming experience.

In summary, the embodiments of the present disclosure provide a method for controlling game image quality. In this method, firstly, in response to receiving the input signal from the game device, the first signal type of the input signal is identified and the game image quality parameter corresponding to the first signal type is determined, then the first game interaction mode is obtained and the image quality parameter offset corresponding to the first game interaction mode under the first signal type is determined, and then the target image quality parameter is calculated according to the game image quality parameter corresponding to the first signal type and the image quality parameter offset corresponding to the first game interaction mode, so as to control the display of the display apparatus to display the game screen according to the target image quality parameter. In the present disclosure, the image quality effect of the game screen can be automatically updated according to the input signal of the game device and the first game interaction mode, thereby avoiding the adverse impact on the game caused by a single image quality effect on the game and improving the user experience.

The embodiments of the present disclosure provide a computer-readable storage medium on which a computer program is stored. When the computer program is executed by one or more processors, the various processes of the above-mentioned method for controlling the game image quality are implemented, and the same technical effect can be achieved. To avoid repetition, it will not be described here.

The computer readable storage medium may be a read-only memory (ROM), a random access memory (RAM), a magnetic disk or an optical disk, etc.

The present disclosure provides a computer program product, which includes a computer program. When the computer program is run on a computer, the computer implements the above-mentioned method for controlling game image quality.

What is claimed is:

1. A display apparatus, comprising:
a display, configured to display an image from a broadcast system or Internet, and/or display a user interface;
an external device interface, comprising one or more high-definition multimedia interfaces (HDMI) and configured to connected with an external device;
a memory, configured to store instructions and data associated with the display
at least one processor, connected to the display, the external device interface, and the memory, and configured to execute the instructions to cause the display apparatus to perform:
based on that a game device is connected to the display apparatus through the one or more HDMI, in response to receiving an input signal of the game device, identifying a first signal type of the input signal, determining a game image quality parameter corresponding to the first signal type, and displaying a game screen according to the game image quality parameter corresponding to the first signal type;
in response to a selection command input from a user in a setting interface, determining an image quality parameter offset corresponding to a first game interaction mode under the first signal type; wherein the selection command is configured to indicate the first game interaction mode selected by the user, and the first game interaction mode comprises at least one of: a standard mode, a first-person shooting mode, a role-playing mode, a real-time strategy mode, a sports mode, or an automatic mode;
performing a superposition calculation on the game image quality parameter corresponding to the first signal type and the image quality parameter offset corresponding to the first game interaction mode to obtain a first target image quality parameter;
controlling the display to display a game screen according to the first target image quality parameter.

2. The display apparatus according to claim 1, wherein the at least one processor is configured to execute the instructions to cause the display apparatus to perform:
in response to receiving the input signal of the game device, identifying the first signal type of the input signal, and switching an image mode of the display apparatus to the standard mode in the first game interaction mode under the first signal type; wherein the first signal type is one of a high dynamic range (HDR) type, a standard dynamic range (SDR) type, or a Dolby (DOLBY) type;
retrieving the game image quality parameter corresponding to the first signal type from a first storage address; wherein the first storage address is configured to store different game image quality parameters corresponding to different first signal types; and
controlling the display to display the game screen according to the game image quality parameter corresponding to the first signal type.

3. The display apparatus according to claim 2, wherein the game image quality parameter corresponding to the first signal type is a game image quality parameter corresponding to the standard mode in the first game interaction mode under the first signal type, and the game image quality parameter comprises at least one of a backlight parameter, an image brightness, contrast, chroma, or definition.

4. The display apparatus according to claim 3, wherein image quality parameter offsets corresponding to different first game interaction modes are stored in a second storage address, and an image quality parameter offset corresponding to the standard mode is 0.

5. The display apparatus according to claim 1, wherein the at least one processor is configured to execute the instructions to cause the display apparatus to perform:
based on that a game screen is displayed on the display with a game image quality parameter corresponding to the standard mode in the first game interaction mode under the first signal type, in response to receiving the selection command input from the user in the setting interface, retrieving the image quality parameter offset corresponding to the first game interaction mode under the first signal type from a second storage address;
wherein the second storage address is configured to store image quality parameter offsets corresponding to different first game interaction modes.

6. The display apparatus according to claim 3, wherein the at least one processor is configured to execute the instructions to cause the display apparatus to perform:
based on that a game screen is displayed on the display with the game image quality parameter corresponding to the standard mode in the first game interaction mode under the first signal type, identifying the game screen to obtain a game scene, and determining the first game interaction mode corresponding to the game scene; wherein the first game interaction mode is any one of the standard mode, the first-person shooting mode, the role-playing mode, the real-time strategy mode, or the sports mode;
retrieving the image quality parameter offset corresponding to the first game interaction mode under the first signal type from a second storage address; wherein the second storage address is configured to store image quality parameter offsets corresponding to different first game interaction modes.

7. The display apparatus according to claim 5, wherein the at least one processor is further configured to execute the instructions to cause the display apparatus to perform:
superposing the game image quality parameter corresponding to the first signal type in the first storage address and the image quality parameter offset corresponding to the first game interaction mode under the first signal type in the second storage address to obtain the first target image quality parameter;
displaying the game screen according to the first target image quality parameter.

8. The display apparatus according to claim 1, wherein the at least one processor is further configured to execute the instructions to cause the display apparatus to perform:
based on that a switching signal is received and the switching signal indicates that the game device connected to the display apparatus is switched, identifying a second signal type corresponding to the switching signal;
based on that the second signal type is different from the first signal type, obtaining a game image quality parameter corresponding to the second signal type, and determining an image quality parameter offset corresponding to a first game interaction mode under the second signal type;
performing a superposition calculation on the game image quality parameter corresponding to the second signal type and the image quality parameter offset corresponding to the first game interaction mode under the second signal type to obtain a second target image quality parameter;
controlling the display to update image quality of the game screen according to the second target image quality parameter.

9. The display apparatus according to claim 1, wherein the at least one processor is further configured to execute the instructions to cause the display apparatus to perform:
in response to a user input indicating a switch to a second game interaction mode, obtaining an image quality parameter offset corresponding to the second game interaction mode under the first signal type;
performing a superposition calculation on the game image quality parameter corresponding to the first signal type and the image quality parameter offset corresponding to the second game interaction mode under the first signal type to obtain a third target image quality parameter;
controlling the display to update image quality of the game screen according to the third target image quality parameter.

10. The display apparatus according to claim 1, wherein the at least one processor is further configured to execute the instructions to cause the display apparatus to perform:
after identifying the first signal type of the input signal in response to receiving the input signal of the game device, controlling the display to display an identifier of the first signal type in the setting interface.

11. A method for controlling game image quality, comprising:
based on that a game device is connected to a display apparatus through one or more high-definition multimedia interfaces (HDMI), in response to receiving an input signal of the game device, identifying a first signal type of the input signal, determining a game image quality parameter corresponding to the first signal type, and displaying a game screen according to the game image quality parameter corresponding to the first signal type;
in response to a selection command input from a user in a setting interface, determining an image quality parameter offset corresponding to a first game interaction mode under the first signal type; wherein the selection command is configured to indicate the first game interaction mode selected by the user, and the first game interaction mode comprises at least one of: a standard mode, a first-person shooting mode, a role-playing mode, a real-time strategy mode, a sports mode, or an automatic mode;
performing a superposition calculation on the game image quality parameter corresponding to the first signal type and the image quality parameter offset corresponding to the first game interaction mode to obtain a first target image quality parameter;
controlling a display to display a game screen according to the first target image quality parameter.

12. The method according to claim 11, the in response to receiving an input signal of the game device, identifying a first signal type of the input signal, determining a game image quality parameter corresponding to the first signal type, and displaying a game screen according to the game image quality parameter corresponding to the first signal type, comprises:
in response to receiving the input signal of the game device, identifying the first signal type of the input signal, and switching an image mode of the display apparatus to the standard mode in the first game interaction mode under the first signal type; wherein the first signal type is one of a high dynamic range (HDR) type, a standard dynamic range (SDR) type, or a Dolby (DOLBY) type;
retrieving the game image quality parameter corresponding to the first signal type from a first storage address; wherein the first storage address is configured to store different game image quality parameters corresponding to different first signal types; and
controlling the display to display the game screen according to the game image quality parameter corresponding to the first signal type.

13. The method according to claim 12, wherein the game image quality parameter corresponding to the first signal type is a game image quality parameter corresponding to the standard mode in the first game interaction mode under the first signal type, and the game image quality parameter comprises at least one of a backlight parameter, an image brightness, contrast, chroma, or definition.

14. The method according to claim 13, wherein image quality parameter offsets corresponding to different first game interaction modes are stored in a second storage address, and an image quality parameter offset corresponding to the standard mode is 0.

15. The method according to claim 11, further comprising:
based on that a game screen is displayed on the display with a game image quality parameter corresponding to the standard mode in the first game interaction mode under the first signal type, in response to receiving the selection command input from the user in the setting interface, retrieving the image quality parameter offset corresponding to the first game interaction mode under the first signal type from a second storage address;
wherein the second storage address is configured to store image quality parameter offsets corresponding to different first game interaction modes.

16. The method according to claim 13, further comprising:
based on that a game screen is displayed on the display with the game image quality parameter corresponding to the standard mode in the first game interaction mode under the first signal type, identifying the game screen to obtain a game scene, and determining the first game interaction mode corresponding to the game scene; wherein the first game interaction mode is any one of the standard mode, the first-person shooting mode, the role-playing mode, the real-time strategy mode, or the sports mode;
retrieving the image quality parameter offset corresponding to the first game interaction mode under the first signal type from a second storage address; wherein the second storage address is configured to store image quality parameter offsets corresponding to different first game interaction modes.

17. The method according to claim 15, further comprising:
superposing the game image quality parameter corresponding to the first signal type in the first storage address and the image quality parameter offset corresponding to the first game interaction mode under the first signal type in the second storage address to obtain the first target image quality parameter;
displaying the game screen according to the first target image quality parameter.

18. The method according to claim 11, further comprising:
based on that a switching signal is received and the switching signal indicates that the game device connected to the display apparatus is switched, identifying a second signal type corresponding to the switching signal;
based on that the second signal type is different from the first signal type, obtaining a game image quality parameter corresponding to the second signal type, and determining an image quality parameter offset corresponding to a first game interaction mode under the second signal type;
performing a superposition calculation on the game image quality parameter corresponding to the second signal type and the image quality parameter offset corresponding to the first game interaction mode under the second signal type to obtain a second target image quality parameter;
controlling the display to update image quality of the game screen according to the second target image quality parameter.

19. The method according to claim 11, further comprising:
in response to a user input indicating a switch to a second game interaction mode, obtaining an image quality parameter offset corresponding to the second game interaction mode under the first signal type;
performing a superposition calculation on the game image quality parameter corresponding to the first signal type and the image quality parameter offset corresponding to the second game interaction mode under the first signal type to obtain a third target image quality parameter, controlling the display to update image quality of the game screen according to the third target image quality parameter.

20. A non-transitory computer readable storage medium, wherein the non-transitory computer storage medium stores computer programs, and the computer programs are executed by at least one processor to perform the method for controlling game image quality according to claim 11.
